(19) United States
(12) Patent Application Publication
(10) Pub. No.: US 2013/0276254 A1
(43) Pub. Date: Oct. 24, 2013

(54) Windeck Lawn Mower Blower Attachment Device

(71) Applicants: Steve Norton, Kalamazoo, MI (US); Brian Morga, Paw Paw, MI (US); Carl Orosz, Kalamazoo, MI (US); Devon Jackson, Kalamazoo, MI (US)

(72) Inventors: Steve Norton, Kalamazoo, MI (US); Brian Morga, Paw Paw, MI (US); Carl Orosz, Kalamazoo, MI (US); Devon Jackson, Kalamazoo, MI (US)

(21) Appl. No.: 13/651,403

(22) Filed: Oct. 13, 2012

Related U.S. Application Data
(63) Continuation-in-part of application No. 13/159,608, filed on Jun. 14, 2011, now abandoned.

(51) Int. Cl. A01D 34/00

(52) U.S. Cl. CPC A01D 34/001
USPC 15/246

(57) ABSTRACT

An apparatus for creating a strong force of concentrated energy and a blowing force of air pressure in cooperation with an industrial, commercial or home care lawn mower. This device is a new combination of existing materials configured with unique features that provide an effective, practical and economical way to provide an air blower device. It is comprised of a main deck with features with two or more air ducts, a series of baffles to direct the air movement through the deck, and an exhaust duct; of at least one blower fan; and of a means to secure the main deck and blowers to a mower device.

### CROSS-REFERENCE TO RELATED APPLICATIONS

This application is a Continuation-in-Part [C.I.P.] filed under 37 CFR 1.53(b) and claims the benefit of the original, non-provisional (Regular Utility) U.S. patent application Ser. No. 13/159,608 submitted Jun. 11, 2011 and Published Dec. 22, 2011 as US 2011-0308216 A1. The original application was active on the date of the submission of this C.I.P. The original application and publication are entitled a “Windeck Lawn Mower Blower Attachment Device” and were submitted by Steve Norton, et al. The original application is incorporated fully by reference as if it were reproduced here, verbatim. This application also claims the benefit of Provisional Patent Application Ser. No. 61/356,594 filed Jun. 19, 2010 by Stephen Norton et al and entitled “Windeck Lawn Mower Blower Attachment Device”.

### FIELD OF INVENTION

This invention relates to an apparatus for creating a strong force of concentrated energy and more particularly, but not by way of limitation, an apparatus for creating a blowing force of air pressure in cooperation with an industrial, commercial or home care lawn mower. Particularly this new device is related to devices and methods to create and provide a strong force of air in a safe and efficient manner when used with a mower device or equal. This Windeck Lawn Mower Blower Attachment Device is a new combination of existing materials configured with unique features that provide an effective, practical and economical way to provide an air blower device. The preferred and alternative embodiments are described below.

### FEDERALLY SPONSORED RESEARCH

None.

### SEQUENCE LISTING OR PROGRAM

None.

### BACKGROUND

### Field of Invention and Prior Art

### A. Introduction of the Problems Addressed

The use of air being blown to create a strong force which can move materials is desirable for many applications—debris and trash; lawn clippings and leaves; snow; etc. Often one finds people needing to harness and provide such an air blowing force resort to using and procuring a special piece of equipment to accomplish that need. What is addressed and solved by this Windeck Lawn Mower Blower Attachment Device is a means to quickly and easily adapt an existing mower of various sizes to harness and to provide a strong air blower. The device and scope of the invention shows that existing equipment combined with this Windeck device solves the need for a manner and means to harness exhaust air from a mower and direct it for the operators use in many desired applications. As far as known, there is no other mower blower attachment or related devices at the present time which fully provide these improvements and functional characteristics as the present Windeck Lawn Mower Blower Attachment Device. It is believed that this device is made with fewer parts with improved configurations and physical features to provide more functionality when compared to other currently utilized air blowing devices or auxiliary equipment aids.

The particular combinations of materials and features are unique and novel and are not anticipated by prior art. Likewise, use of a Windeck Lawn Mower Blower Attachment Device provides significant benefits compared to prior art devices.

### B. Prior Art

In prior art, disclosures have been made—many including large, complex devices and systems created to sweep or cause air to move materials such as grass, snow and debris. These are not only more costly to manufacture but lack the efficiency and ease of attaching the device(s) to the mowers demonstrated by the Windeck.

A motor lawn mower and sweeper was first taught by Coldwell in U.S. Pat. No. 796,811 issued in 1905. It shows a combination unit of cutting blades that are propelled and a mechanical sweeper. There is no teaching of the exhaust or auxiliary air movement used for any purpose. Another device by Thoen et al in U.S. Pat. No. 3,690,047, issued in 1972, shows a utility device that is a combination lawn mower and snow thrower. It teaches a combination lawn mower and snow blower wherein a rotary impeller member has a series of spaced disks axially mounted in spaced parallelism along a shaft with the disks being disposed at a substantially 45 degree angle to the shaft axis. The beater bars will cut through snow or grass and the disks will move the material rear-wardly under the shaft for upward ejection through a beater housing. The dual function machine is an integrated design and does not adapt to the various types of mower decks as the new Windeck demonstrates.

A garden grooming machine and rotor is taught in the U.S. Pat. No. 3,783,592 issued to Schraut in 1974. Here a self-propelled lawn vacuum, mower and sweeper having interchangeable reel-type mower and rotary brush units, both are feeding material tangentially toward the intake of the vacuum. The drive wheels are spring-loaded to follow the ground contour, and the height of the interchangeable units with respect to the vacuum is adjustable. A moveable shutter is interposed between the mower and brush units and the vacuum intake to regulate air flow. The device is integrated into the full mower and not adaptable across various deck types and sizes as is the Windeck.

A fully integrated, two-wheeled device is taught by Spinner as shown in U.S. Pat. No. 4,064,679 issued in 1977. This is a multi-use lawn care machine which can be used as a lawn mower, lawn sweeper or snow blower. The machine has a generally cylindrical housing to hold the tool (a snow blower reel, lawn mower reel, or lawn sweeper attachment) in use. One side plate of the housing is laterally removable, permitting access to and disconnection of the tool. A front wheel is mounted on the removable side plate. A front cover is removably attached to close the front of the housing when the machine is used as a lawn mower or lawn sweeper. The device is very complicated with many more moving and static parts than the Windeck. Another device is demonstrated in U.S. Pat. No. 4,996,829 issued in 1991 to Saitoh et al. It is a much more complex device than the simple Windeck. The lawn mower with blower is described as a riding lawn mower comprised of a frame supported by wheels, a mower housing carried at the underside of the frame, a plurality of cutter blades located within the mower housing to cut grass, a collection bag mounted on the rear of the frame, a discharge chute extending between the mower housing and the collection bag and defining a clipping path from the cutter blades into the collection bag, a blower including an impeller housing attached to the mower housing and an impeller located within the impeller housing and cooperating with the butter blades to convey the grass clippings into the collection bag through the discharge chute. Further, a short conduit connects the impeller housing to the upstream end of the discharge chute to conduct an air generated by the impeller into the discharge chute. Finally, a central axis of the conduit is shown as offset downwardly from a central axis of the discharge chute.

A lawn mower with a blower unit was issued in 1991 to Samejima et al as a U.S. Pat. No. 5,018,344. Here is a lawn mower comprising a blade housing supported above the ground by wheels, and a blower case removably connected to one lateral side of the blade housing for blowing grass clippings toward a grass catcher disposed rearwardly of a vehicle body. The blade housing carries wheel support frames secured thereto and extending in a fore and aft direction of the vehicle body. A forward coupling and a rear coupling are secured to one of the wheel support frames for connecting the blower case to the blade housing. The device again, like the other prior art, is complicated and has more components than the Windeck invention shown herein. Another complex snow blower and lawn mower apparatus was issued as a U.S. Pat. No. 5,090,142 to Peters in 1992. Here is taught an attachment arranged for mounting to an associated lawnmower in an operative relationship to include a snow blower housing operative through a plurality of inter-related belts and pulleys to effect rotation of a plurality of impeller blades mounted within the snow blower housing. A drive pulley is mounted to a lower terminal end of the lawnmower motor output shaft to operatively effect the afore noted rotation of the impeller structure.

Other prior art is a converted lawn mower taught by Woelffer in the U.S. Pat. No. 3,863,291 issued in 1975. While this does show a single fan blower, it is a full conversion that takes complex change-over and Woelffer describes the conversion of a full rotary mower device whereas the applicant (Norton) device is an attachment that may be used with many types of mowers without appreciable changes to the mower since the attachment connects to the perimeter of the mower deck. Woelffer does not teach these limitations. Likewise, Woelffer describes a rotary mower with one shaft whereas the applicant's attachment has at least one blower [ie or more] and the drawings of the attachment show space for more than one blower. Woelffer does not teach these limitations. In addition, Woelffer describes and shows the bottom plate 32 as flat whereas the applicant Norton et al. shows and has amended the claim to show the baffles and air ducts to fully direct the air and narrow the cross-section of the exhaust. Woelffer does not teach these limitations. Another U.S. patent Hansen as U.S. Pat. No. 4,187,577 issued in 1980. This was a blower attachment for a line trimmer and varies greatly from the Norton invention. It has a much smaller, single blower and complex cable attachment. It lacks the scope and spirit of the Norton, et al adapter kit shown herein.

### SUMMARY OF THE INVENTION

A Windeck Lawn Mower Blower Attachment Device has been developed and designed to provide a unique combination that is specifically related to devices and methods to provide an improved device for producing or rather transforming energy of a mower or tractor to air pressure or wind energy from a blower or the like. The Windeck Lawn Mower Blower Attachment Device may be used to easily and safely blow leaves, grass, debris and snow from a lawn or surface. The benefits are delineated below.

The preferred embodiment of the Windeck Lawn Mower Blower Attachment Device is comprised of a removable main deck with various features such as an inlet air chamber; one or more air ducts; a series of baffles to direct the air movement through the device; and an exhaust duct all of which, including the features, are made of durable materials, and as a preferred embodiment at least one blower fans; and means to secure the main deck and blowers to a mower device. An alternative embodiment anticipates at least one blower and a means to connect the blower(s) to the mower but without the main deck to the air flow without the same force as the preferred with the main deck and features.

### OBJECTS AND ADVANTAGES

There are several objects and advantages of the Windeck Lawn Mower Blower Attachment Device. There are currently no known Windeck Lawn Mower Blower Attachment Device or other air power and blower devices that are effective at providing the objects of this invention.

The following TABLE A summarizes various advantages and objects of the Windeck Lawn Mower Blower Attachment Device. This list is exemplary and not limiting to the many advantages offered by this new device.

TABLE A
Various Benefits, Advantages and Objects This device:

| ITEM | BENEFIT |
|---|---|
| 1. | Much stronger and more powerful than traditional air |
| | blower devices |
| 2. | Uses existing equipment (mowers) for base power and |
| | converts its exhaust to wind energy |
| 3. | May be used with existing mowers |
| 4. | Is quick to change-over from cutting or mulching to |
| | blowing. |
| 5. | May be manufactured in an inexpensive manner with |
| | existing processes and equipment. |
| 6. | May be both installed and removed quickly. |
| 7. | May be stored in a relatively small area. |
| 8. | Is adaptable to various sized mowers. |
| 9. | Is easy to package and transport |
| 10. | Can be sold and distributed retail, wholesale, or E- |
| | commerce internet sales from a website |
| 11. | May have various outer configurations to adapt to |
| | different marketing themes. |
| 12. | May be used during all seasons |
| 13. | May be manufactured from various durable materials |
| | such as metal - steel, steel alloys, aluminum, etc. |
| | or composites - plastics, reinforced plastics, etc. |

Noteworthy is that other advantages and additional features of the present Windeck Lawn Mower Blower Attachment Device will be more apparent from the accompanying drawings and from the full description of the device. For one skilled in the art of air blower devices especially for lawn care, it is readily understood that the features shown in the examples with this device is readily adapted for improvement to other types of mechanisms and devices for use as an air blowing device or accessory.

### DESCRIPTION OF THE DRAWINGS

### Figures

The accompanying drawings, which are incorporated in and constitute a part of this specification, illustrate a preferred and alternative embodiments for the Windeck Lawn Mower Blower Attachment Device. The drawings together with the summary description given above and a detailed description given below serve to explain the principles of the Windeck Lawn Mower Blower Attachment Device. It is understood, however, that the device is not limited to only the precise arrangements and instrumentalities shown.

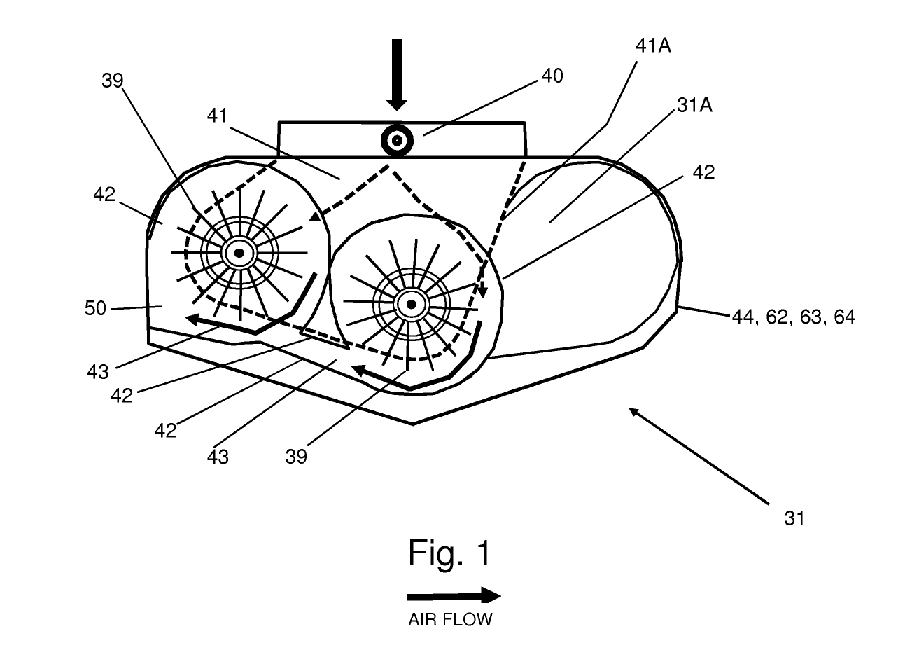

FIG. 1 is the general view of the Windeck Lawn Mower Blower Attachment Device with features and components identified.

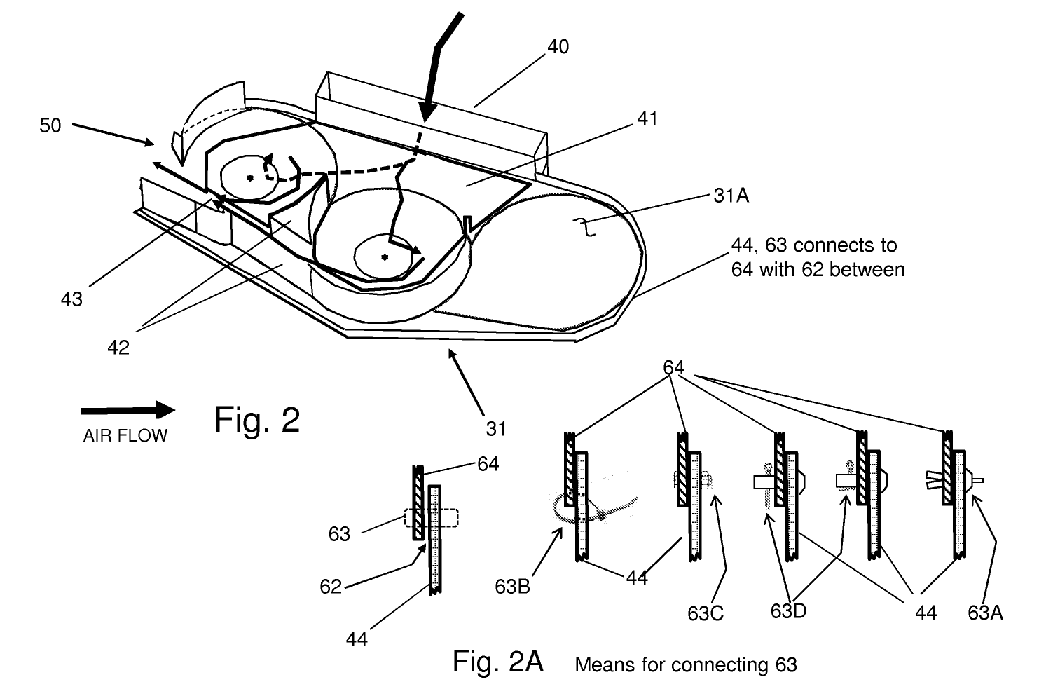

FIG. 2 and FIG. 2A are Windeck housing details without blower fans and are means for connecting examples.

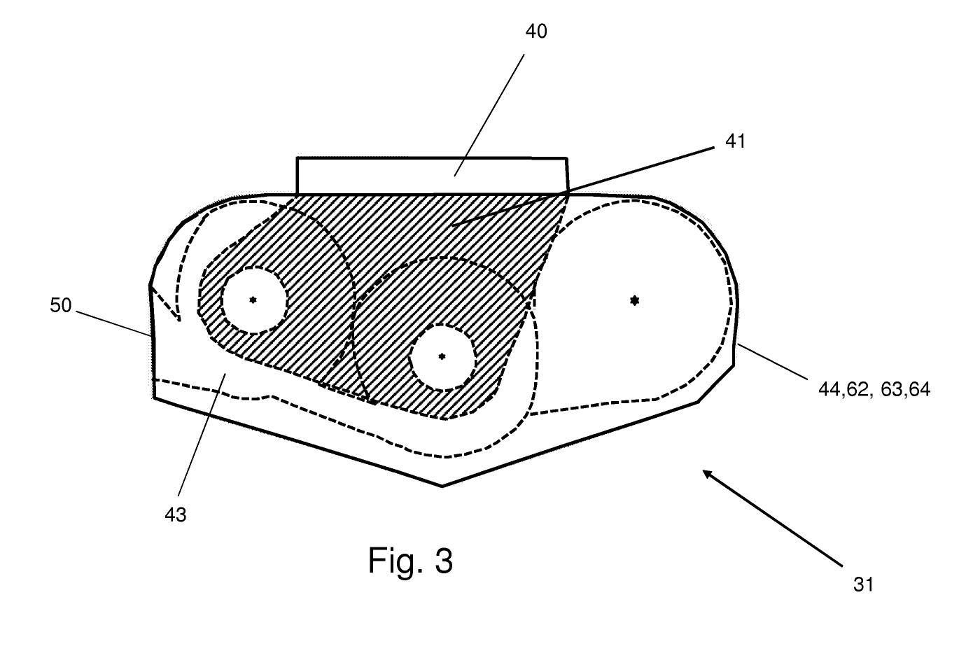

FIG. 3 is a Windeck top view without blower fans.

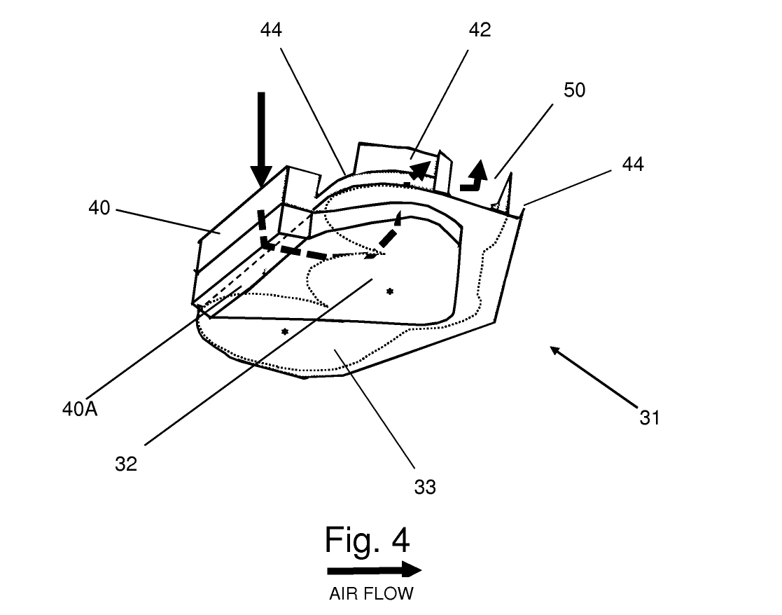

FIG. 4 is a Windeck with the general view of air ducts chamber underside.

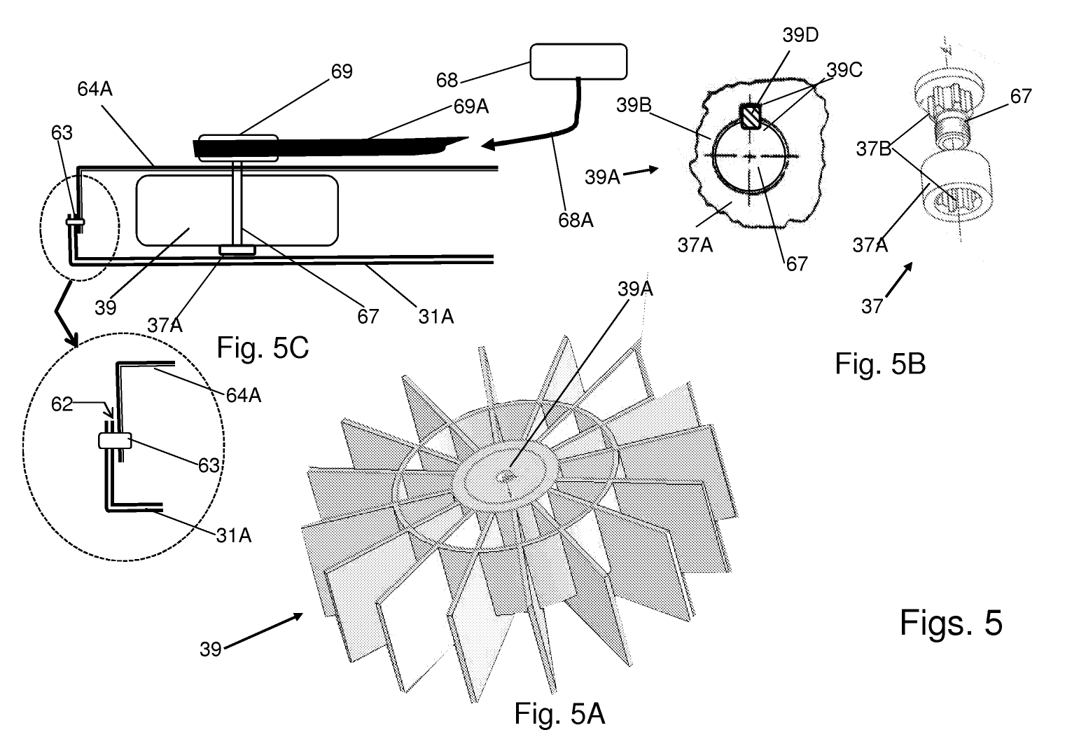

FIG. 5A is an isometric of a typical blower fan, FIG. 5 B are an attachment devices, and FIG. 5 C shows the attachment scheme of the deck and blower(s).

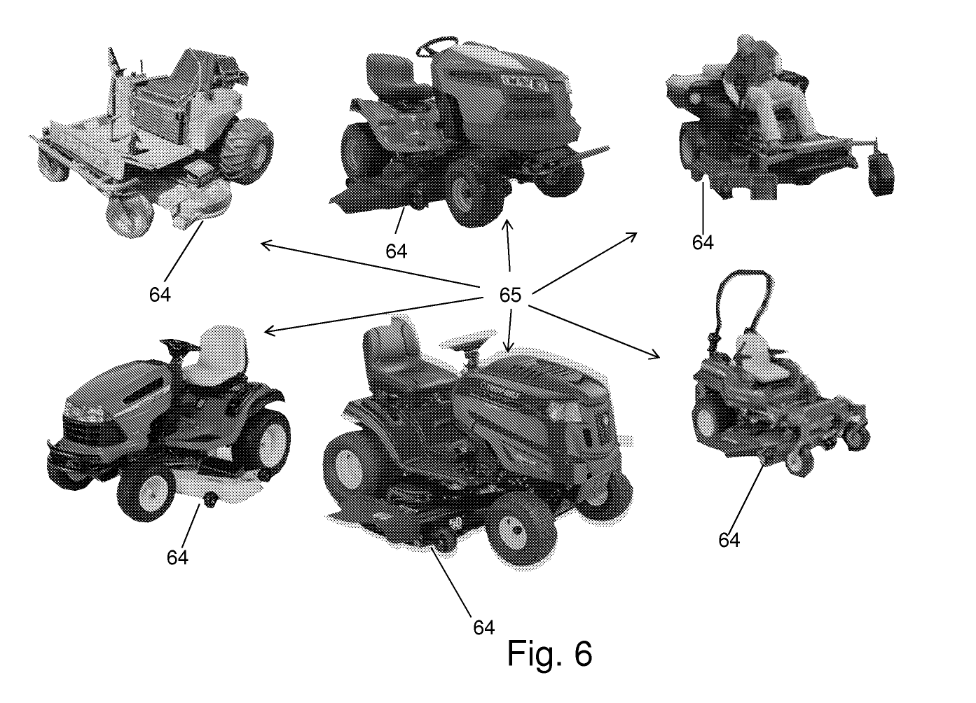

FIG. 6 shows pictures of various tractors able to accept a Windeck device.

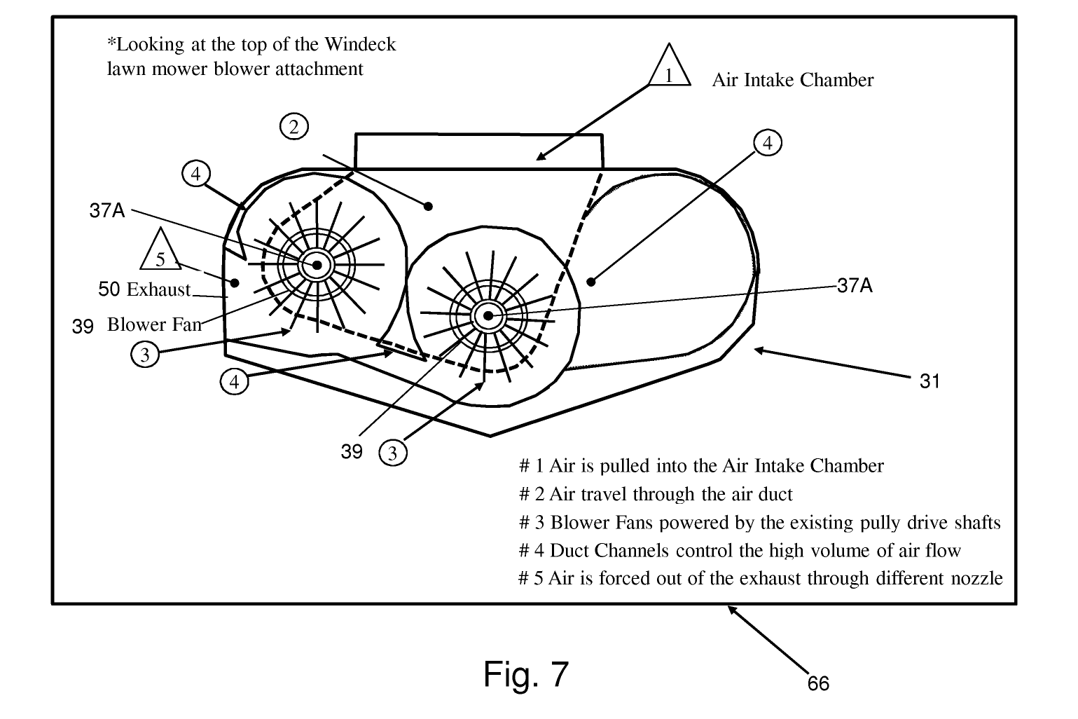

FIG. 7 shows the general specifications and description of the Windeck device.

### REFERENCE NUMERALS

The following list refers to the drawings:

TABLE B
Reference numbers

| Ref # | Description |
|---|---|
| 31 | General Windeck Lawn Mower Blower Attachment Device |
| 31A | main deck with Top exterior face of general Windeck 31 |
| 32 | Bottom exterior face of lower air duct |
| 33 | Bottom exterior face of general windeck |
| 37 | Means for connecting driven pulley 69 shaft 67 body to |
| | pole/shaft adapter 37A of fans 39 (such as an |
| | internal and external spline 37B or the like) |
| 37A | Pole or shaft adapter |
| 37B | Internal and external spline |
| 39 | Blower Fan(s) |
| 39A | Means for Mounting [shaft aperture 39B, keyways 39C and |
| | key 39D blower] the pole/shaft adapter 37A to mower |
| | shaft 67 |
| 39B | Shaft clearance aperture in means 39A |
| 39C | Matching Keyways on both shaft 67 and means 39A |
| 39D | Key from stock |
| 40 | Air Intake chamber |
| 40A | Aperture between air intake chamber and lower air duct |
| 41 | Lower Air Duct |
| 41A | Perimeter of Lower air duct |
| 42 | Upper Duct baffle plates |
| 43 | Upper Air Duct |
| 44 | Windeck edge perimeter |
| 50 | Exhaust port |
| 62 | Gap and clearance between the Windeck 31 main deck 31A |
| | and a mower deck 64A at the perimeters 44, 64 |
| 63 | Means for removably attaching Windeck 31 under a mower |
| | deck 64A at the perimeters 44, 64 |
| 63A | barbs (plastic, metal, or composite materials) |
| 63B | cable ties (plastic, metal, or composite materials) |
| 63C | threaded bolts and nuts (plastic, metal, or composite |
| | materials) |
| 63D | cotter pins and keepers and the like (plastic, metal, or |
| | composite materials) |
| 64 | Mower deck perimeter |
| 64A | Mower deck |
| 65 | Various mowers with decks 64A and motor drive shafts 67 |
| 66 | Description sheet for windeck |
| 67 | Existing pulley drive shaft(s) powered through a belt |
| | and/or chain drive to pulleys from engine 68 of mower 65 |
| 68 | Engine of mower 65 68A 69A |
| 68A | means for powering and driving the chain/belt 69A |
| 69 | Driven pulleys |
| 69A | chain/pulley drive |
| → | Air flow nominal direction |

### DETAILED DESCRIPTION OF PREFERRED EMBODIMENT

This invention relates to an apparatus for creating a strong force of concentrated energy and more particularly, but not by way of limitation, an apparatus for creating a blowing force of air pressure in cooperation with an industrial, commercial or home care lawn mower. Particularly this new device is related to devices and methods to create and provide a strong force of air in a safe and efficient manner when used with a mower device or equal. This Windeck Lawn Mower Blower Attachment Device 31 is a new combination of existing materials configured with unique features that provide an effective, practical and economical way to provide a air blower device. The preferred and alternative embodiments are described below. The preferred embodiment of the Windeck Lawn Mower Blower Attachment Device 31 is comprised of a removable main deck with various features such as an inlet air chamber; at least two or more air ducts; a series of baffles to direct the air movement through the device; and an exhaust duct all of which, including the features, are made of durable materials, and as a preferred embodiment at least one blower fan; and means to secure the main deck and blowers to a mower device. An alternative embodiment anticipates at least one blower and a means to connect the blower(s) to the mower but without the main deck to direct the air flow and with relatively less force as the preferred with the main deck and features.

There is shown in FIG. 1 through FIG. 7 a complete detail and operative embodiment of the Windeck Lawn Mower Blower Attachment Device 31. In the drawings and illustrations, one notes well that the FIG. 1 through FIG. 5 detail the special configuration and FIGS. 1, 2, 4, and 7 show the operative use of this invention. FIG. 6 shows several mowers that the device 31 is used with as an accessory. The operation of the Windeck Lawn Mower Blower Attachment Device 31 is discussed below in the Operations section.

The advantages for the Windeck Lawn Mower Blower Attachment Device 31 are listed above in the introduction. Succinctly the benefits are the device:
Is much stronger and more powerful than traditional air blower devices.
Uses existing equipment (mowers) for base power and converts it to wind energy.
May be used with existing mowers.
Is quick to change-over from cutting or mulching to blowing.
May be manufactured in an inexpensive manner with existing processes and equipment.
May be both installed and removed quickly.
May be stored in a relatively small area.
Is adaptable to various sized mowers.
Can be sold and distributed retail, wholesale, or E-commerce internet sales from a website.
May have various outer configurations to adapt to different marketing themes.
May be used during all seasons
May be manufactured from various durable materials such as metal—steel, steel alloys, aluminum, etc. or composites—plastics, reinforced plastics, etc.

The preferred embodiment of the Windeck Lawn Mower Blower Attachment Device is comprised of (a) at least one blower fan 39 that creates an air movement →; (b) a main deck 31A comprised of an inlet air chamber 40; at least one air duct 41, 42 with two ends, the duct being connected to the main deck 31A and having one end of the duct at the air inlet chamber 40 and the other end at an exhaust port 50; a series of baffles connected to the main deck 31A, the baffles configured to direct and to constrict the air movement →, a perimeter of the main deck 31A; and features to permit mounting the main deck to a perimeter 44 of a deck 64A of a mower device 65; (c) a gap and clearance space 62 interposed between the perimeter 44 of the main deck 31A and the perimeter of the mower deck 64 once the main deck 31A is placed contiguously outside the perimeter 64 of the mower deck 64A; (d) a means 63 to quickly secure the main deck 31A under a contiguous mower deck 64A at the perimeters 44, 64 of the main deck 31A and the mower deck 64; and (e) a means 39A, 37 to secure the at least one blower fan 39 under the mower device 65 wherein the at least one blower fan 39; the inlet air chamber and the direction of the air by the baffles increase the air pressure of the mower device by the constriction of the air ducts and an exhaust at the exhaust port results in a strong and powerful airflow →. An alternative embodiment anticipates at least one blower and a means to connect the blower(s) to the mower but without the main deck under the mower to direct the air flow with relatively less same force as the preferred with the main deck and features.

The accompanying drawings, which are incorporated in and constitute a part of this specification, illustrate a preferred embodiment of the Windeck Lawn Mower Blower Attachment Device 31. The drawings together with the summary description given above and a detailed description given below serve to explain the principles of the Windeck Lawn Mower Blower Attachment Device 31. It is understood, however, that the Device 31 is not limited to only the precise arrangements and instrumentalities shown.

FIG. 1 is the general view of the Windeck Lawn Mower Blower Attachment Device 31 with features and components identified. The preferred embodiment of the Windeck Lawn Mower Blower Attachment Device 31 is comprised of a removable main deck 31A with various features such as an inlet air chamber 40; one or more air ducts 41,43; a series of baffles 42 to direct the air movement through the device; and an exhaust duct 50. All of these features and the main deck 31A are made of durable materials, and as a preferred embodiment at least one blower fan; and means to removably secure 63 and 37 the main deck 31A and blowers 39 underneath a mower device. An alternative embodiment anticipates at least one blower 39 and a means 37 to removably connect the blower(s) to the mower but without the main deck 31A under the mower to create the air flow without relatively less force as the preferred with the main deck 31A and features. This removable securement means 37 anticipates a mechanical fastening means such as splines, and means 63 for removably attaching anticipates barbs 63A (plastic, metal, composite), cable ties 63B, threaded bolts and nuts 63C, or cotter pins and keepers 63D and the like. The durable material anticipated for the Windeck Lawn Mower Blower Attachment Device 31 is a metal (such as steel, steel alloy, aluminum or the like) or composite material, or the like. One skilled in material selection well appreciates the plethora of materials—both natural and man-made composites—that may fully support the scope and spirit of this invention. These stated materials are exemplary and not limiting in scope. The air flow arrows are discussed below with operations.

FIG. 2 is a Windeck housing without blower fans 39 and FIG. 2A are means 63 for connecting perimeters 44, 64 (of the deck 31 of the Windeck 31 and mower deck 64A respectively). The preferred embodiment of the Windeck Lawn Mower Blower Attachment Device 31 is comprised of a removable main deck 31A; an inlet air chamber 40; one or more air ducts 41,43; a series of baffles 42 to direct the air movement through the device; and an exhaust duct 50. At the exhaust duct 50 various hose adapters, deflector vanes and the like may be easily attached. One notes the perimeter 44 of the deck 31A of the device 31 is noted. Contiguous to this perimeter is the mower deck 64 of the mower 65 (not shown). There is a removable securement means 63 as discussed below to secure the device 31 under the mower 65 at their respective deck perimeters 44, 64. Once connected, the main deck 31A creates the lowermost surface of the ducts (and baffles). All of these features and the main deck 31A are made of durable materials (plastic, metal, or composite materials). The air flow arrows are discussed below with the description of operations. FIG. 2A are means for connecting examples. First is shown the general means 63 for connecting the perimeter 44 of the deck 31A to the mower deck perimeter 64. By securing the perimeters 44, 64 tightly, the air gap and clearance 62 is minimized as the perimeters od the mower deck is fitted inside the main deck contiguously and tightly. One skilled in the art of similar sheet configurations such as sheet metal, plastic sheets or the like well appreciates that if a worn or “ill” fit-up for the perimeters 44, 64 occurs or if one art is worn or somewhat irregular in shape, a gasket or sealant may close any gaps quickly and effectively. The examples of means for connecting 63 are barbs 63A (plastic, metal, composite), cable ties 63B, threaded bolts and nuts 63C, or cotter pins and keepers 63D and the like. These are examples and not limitations. The means for connecting 63 are made of durable materials such as plastic, metal, or composite materials for example.

FIG. 3 is a Windeck Top View without blower fans 39. The main deck 31A with various features such as an inlet air chamber 40; the lower air duct 41 (shaded), the upper air duct 43; a series of baffles 42 to direct the air movement through the device; and an exhaust duct 50. All of these features and the deck 31A are made of durable materials, and as a preferred embodiment at least one blower fan; and means 63 to removably secure 37 the main deck 31A and means 37 to removably secure the blowers 39 to a mower device 64A.

FIG. 4 is a Windeck with the general view of air ducts chamber from the underside. Here the intake chamber 40 brings air through the aperture 40A and into the lower air duct 41 contained by its underside surface 32. Also shown are the windeck perimeter 44, the baffles 42, and the exhaust duct 50. One also may see the under deck surface 33 of the windeck 31 device. The air flow arrows are discussed below with operations.

FIG. 5A is an isometric of a typical blower fan, FIG. 5 B are an attachment devices, and FIG. 5 C shows the attachment scheme of the deck and blower(s). There are a plethora of fans of various sizes and configurations. The scope of the applicants' invention anticipates various fans 39 that are able to create enough air pressure and force. FIG. 5 B shows the examples of connecting the fans 39 to the drive shaft 67. The scope anticipates connecting the fan 39 to the driven pulley shaft 67 by one removable means 39A such as a key 39D and keyways 39C. Another or an equivalent removable securement means such as the splines 37 secure the pulley shaft 67 and a pole adapter 37A. FIG. 5 C shows the attachment scheme of the deck 64A and blower(s) 39. The mower deck 64A is removably secured by a means 63 that contiguously holds the perimeters 64,44 of the mower deck 64A and Windeck main deck 31A. This completes the sides if the air ducts of the blower system. The fans are driven from the engine 68 to the power or driving means 69A that energizes and turns the pulleys 69 and shafts 67. The shaft 67 is connected to the pole or shaft adapter 37A by a connection means 39A, 37 as shown in FIG. 5 B or by another equal means. Hence the engine 68 powers the driven pulley and shafts 67 by the chain/belt means 69A. These are existing with the various mowers 65. The driven shaft 67 is adapted by the Windeck system 31 and connects to the blowers 39 by a means 37, 39A for connecting to the pulley/shaft adapter 37A. An enlarged view also shows the general means 63 for connecting the perimeter 44 of the deck 31A to the mower deck perimeter 64. By securing the perimeters 44, 64 tightly, the air gap or clearance 62 is minimized as the air ducts are fitted contiguously and tightly. An alternative gasket or sealant is described above.

FIG. 6 shows pictures of various tractors 65 able to accept a Windeck device 31. The device 31 is removably secured to the deck 64 of the tractor 65 by a means for removably securing 63.

FIG. 7 shows the general specification and description of the Windeck device. This is an operational sketch and is explained below.

All of the details mentioned here are exemplary and not limiting. Other components specific to describing a Windeck Lawn Mower Blower Attachment Device 31 may be added as a person having ordinary skill in the field of air blowers and mower accessorial apparatuses well appreciates.

### Operation of the Preferred Embodiment

The preferred embodiment for the Windeck Lawn Mower Blower Attachment Device 31 has been described in the above paragraphs. The manner of how the device operates is described below. One skilled in the art of air blowers and mower accessorial apparatuses will note that the description above and the operation described here must be taken together to fully illustrate the concept of the Windeck Lawn Mower Blower Attachment Device 31.

The preferred embodiment of the Windeck Lawn Mower Blower Attachment Device is comprised of a main deck with various features such as an inlet air chamber; two or more air ducts; a series of baffles to direct the air movement through the device; and an exhaust duct all of which, including the features, are made of durable materials, and as a preferred embodiment at least one blower fans; and means to secure the main deck and blowers to a mower device. An alternative embodiment anticipates at least one blower and a means to connect the blower(s) under the mower but without the main deck to the air flow without the same force as the preferred with the main deck and features.

FIG. 1 is the general view of the Windeck Lawn Mower Blower Attachment Device 31 with features and components identified. The device is described above. Here the sequence shows that the ambient air (dashed arrow line →) is pulled into the air chamber 40; through the aperture 40A (not shown in this view); and into the lower air duct 41. The air is then pulled through one or more blower(s) 39 and discharged into the upper air duct 43 contained by the windeck surface 31A and the baffles 42. The air (solid arrow line →) from the pressure side of the fan(s) 39 then is forced through the upper air duct 43 and out the exhaust duct 50. These multiple ducts and blowers work together. The ducts reduce the cross sections of the airflow path and hence increase the pressure which increases the speed of the airflow. The multiple blowers 39 likewise multiply the power imparted from the engine 68 through the drives chain/belt 69A and to each of the blowers 39. This increases the power of the fans 39 turning which creates the pressure onto the air—hence increased airflow by more blower power and reduced cross sectional areas. The result is a fast, high-pressure exhaust at the exhaust duct 50.

FIG. 2 is a Windeck housing without blower fans. The airflow is shown as just described but the fans 39 are not in the view.

FIG. 4 is a Windeck 31 with the general view of air ducts chamber underside. Once again the ambient air (dashed arrow line →) is pulled into the air chamber 40; through the aperture 40A (shown in this view); and into the lower air duct 41 (with the underside surface 32). The air is then pulled through one or more blower(s) 39 (not shown) and discharged into the upper air duct 43 contained by the windeck surface 31A/33 and the baffles 42. The air (solid arrow line →) from the pressure side of the fan(s) 39 then is forced through the upper air duct 43 and out the exhaust duct 50.

FIG. 7 shows the general specification 66 and description of the Windeck device 31. Note the different numbering of the features is readily understood by the reference numbers (Paragraph [0025], above) and the FIG. 1.

With the above description it is important to understand the many uses possible for this device 31. As an example or illustration and not for limitation of the device, the Table C shows possible uses:

TABLE C
Various USES:

| ITEM | USE |
|---|---|
| 1. | Lawn Care - Grass management after mowing |
| 2. | Airports - blowing off runways |
| 3. | Stadiums - blowing off snow or other debris on turf, as |
| | well as connecting hoses and blowing off debris in |
| | stands |
| 4. | Roads - blowing off debris |
| 5. | Cleaning out gutters - with the proper hose attachment |
| 6. | Racetracks - blowing off debris and light snow |
| 7. | Parking Lots - blowing off debris and light snow |
| 8. | Construction zones - clean up debris and sites |
| 9. | Golf Courses - blowing off debris from fairways |
| 10. | Baseball, Football, Soccer, Softball, Polo, Rugby . . . |
| | etc Fields - Debris cleanup |
| 11. | Leaf Cleanup - pretty much anywhere . . . |
| 12. | Debris cleanup - pretty much anywhere . . . |
| 13. | Light snow removal - pretty much anywhere . . . |

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described in the above paragraphs. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

With the above description it is to be understood that the Windeck Lawn Mower Blower Attachment Device 31 is not to be limited to only the disclosed embodiment. The features of the Windeck Lawn Mower Blower Attachment Device 31 are intended to cover various modifications and equivalent arrangements included within the spirit and scope of the description.

What is claimed is:

1. A Windeck lawn mower blower attachment device made of durable materials and comprised of
(a) at least one blower fan that creates an air movement;
(b) a main deck comprised of an inlet air chamber; at least one air duct with two ends, the duct being connected to the main deck and having one end of the duct at the air inlet chamber and the other end at an exhaust port; a series of baffles connected to the main deck, the baffles configured to direct and to constrict the air movement; a perimeter of the main deck; and features to permit mounting the main deck to a perimeter of a deck of a mower device;
(c) a gap and clearance space interposed between the perimeter of the main deck and the perimeter of the mower deck once the main deck is placed contiguously outside the perimeter of the mower deck; and
(d) a means to quickly secure the main deck under a contiguous mower deck at the perimeters of the main deck and the mower deck; and
(e) a means to secure the at least one blower fan under the mower device
wherein the at least one blower fan; the inlet air chamber and the direction of the air by the baffles increase the air pressure of the mower device by the constriction of the air ducts and an exhaust at the exhaust port results in a strong and powerful airflow.

2. The device according to claim 1 wherein the durable material is a metal.

3. The device according to claim 2 wherein the metal is an aluminum alloy.

4. The device according to claim 2 wherein the metal is a steel alloy.

5. The device according to claim 1 wherein the durable, material is a composite material.

6. The device according to claim 1 wherein the means to quickly secure the main deck to the mower is at least one fastener.

7. The device according to claim 6 wherein the fastener is threaded.

8. Device according to claim 1 wherein the means to secure the at least one blower under the mower device is a spline.

9. Device according to claim 1 wherein the means to secure the at least one blower under the mower device is a key and keyways.

10. The device according to claim 1 wherein the means for securing the decks is at least one cable tie through apertures in the perimeter of the deck and mower.

11. The device according to claim 1 wherein the feature in the main deck are is comprised of
a) apertures for the means to connect the decks contiguously; and
b) the exhaust port with connecting means for attaching other devices.

12. The device according to claim 1 wherein it also has a sealant placed in the gap between the main deck perimeter and the mower deck perimeter.

13. A Windeck lawn mower blower attachment device made of durable material and comprised of
(a) at least one blower fan; and
(b) a means to quickly secure at least one blower under a mower device.

14. A Windeck lawn mower blower attachment device made of durable material and comprised of
(a) at least one blower fan;
(b) a main deck with various features including
1. an inlet air chamber;
2. at least one air duct with two ends, the duct being connected to the main deck and having one end of the duct at the air inlet chamber and the other end at an exhaust port;
3. a series of baffles connected to the main deck, the baffles configured to direct and to constrict the air movement;
4. a perimeter of the main deck; and
5. a set of connecting features to permit mounting the main deck to a perimeter of a deck of a mower device;
(c) a means to quickly secure the main deck around, under and contiguous to a deck of a mower device at the perimeters of the main deck and the perimeter of the deck of the mower device; and
(d) a means to secure the at least one blower fan under a mower device
wherein the at least one blower fan; the inlet air chamber and the direction of the air by the baffles increase the air pressure of the mower device and the exhaust results in a strong and powerful airflow.
